(19) United States
(12) Patent Application Publication
(10) Pub. No.: US 2012/0298578 A1
(43) Pub. Date: Nov. 29, 2012

(54) SYSTEMS AND METHODS FOR FILTRATION

(76) Inventors: Rodney Herrington, Albuquerque, NM (US); John E. Dresty, South Glastonbury, CT (US); Mark K. Winter, Canton, CT (US)

(21) Appl. No.: 13/575,953

(22) PCT Filed: Jan. 25, 2011
(86) PCT No.: PCT/US2011/022476

§ 371 Date: Jul. 29, 2012

Related U.S. Application Data
(60) Provisional application No. 61/300,386, filed on Feb. 1, 2010.
(60) Provisional application No. 61/423,081, filed on Dec. 14, 2010.

(51) Int. Cl. B01D 63/00; B01D 65/02; B01D 29/00; B03C 1/02; B82Y 30/00

(52) U.S. Cl. 210/636; 210/348; 210/321.6; 210/321.83; 210/251; 210/222; 210/500.23; 210/500.1; 210/634; 977/902

(57) ABSTRACT

Filtration systems (40) utilize a pre-treatment method to cause scale formation to occur on particles (94) in the fluid stream (96) rather than on the filter surface and may also destroy microorganisms in the fluid stream. More specifically, but not limited to, a filtration device can be a filtration membrane, such as spiral wound filtration membrane (60), that utilizes an open feed spacer (80), such for example an embossed or printed pattern on the membrane, to create a thin feed spacer channel which replaces a conventional feed spacer mesh material. System (40) further utilizes a treatment device (54) to enable a pulsed power, magnetic, electro-magnetic, electro-static, or hydrodynamic fluid treatment scheme to condition particles in the fluid stream (96) such that scale forming elements precipitate (94) on to the particles in the fluid stream rather than on the filtration surfaces.

### CROSS-REFERENCE TO PROVISIONAL APPLICATIONS

This application claims priority under 35 U.S.C §119(e) to the U.S. provisional patent application No. 61/300,386, entitled “Systems and Methods For Spiral Wound Membrane Filtration”, which was filed on Feb. 1, 2010, the disclosure of which is incorporated herein by reference. Furthermore, this application claims priority under 35 U.S.C §119(e) to the U.S. provisional patent application No. 61/423,081, entitled “Systems and Methods For Spiral Wound Membrane Filtration”, which was filed on Dec. 14, 2010, the disclosure of which is incorporated herein by reference.

### FIELD OF THE INVENTION

The present invention relates to filtration, and more particularly but not exclusively, to membrane filtration systems and methods.

### BACKGROUND OF THE INVENTION

Filtration systems for filtering particulates from fluids may utilize for example fiber filter devices, membrane filter devices or other types of filtration devices.

Membrane systems are capable of micro-filtration, ultra-filtration, nano-filtration, and reverse osmosis filtration. Membrane configurations can include, but not be limited to, flat sheet membranes, hollow fiber membranes and spiral wound membranes. As an example, spiral wound membrane modules for membrane filtration utilize flat membrane sheets which are sandwiched between mesh feed spacers and permeate carriers and are wrapped around a small diameter tube. As feed liquid flows longitudinal through the mesh spacers down the membrane module, liquid is driven through the membrane to separate particles from liquid for the purpose of purifying the liquid. The purified water travels spirally through the permeate carrier to the center tube where the purified water is drawn from the center of the small diameter tube.

There is a need to provide improved systems and methods for filtration, such as membrane filtration.

### SUMMARY OF THE INVENTION

The following summary of the invention is provided to facilitate an understanding of some of technical features related to techniques, apparatus and systems for filtration, such as membrane filtration. Examples of methods, apparatus and systems are described for controlling scale formation and/or fluid flow in the filtration process, A full appreciation of the various aspects of the invention can be gained by taking the entire specification, claims, drawings, and abstract as a whole.

According to one aspect of the present invention, there is provided a system for filtration. The system can have one or more treatment devices for treating the feed solution and one more filtration devices for receiving the treated feed solution. The treatment device can be adapted to treat the feed solution such that scale formation is selectively promoted on particles of the treated feed solution rather than the filtering device filtering the treated feed solution.

According to another aspect of the present invention, there is provided a system for filtration. The system can comprise a filtering means for filtering a feed solution; and treatment means for treating the feed solution such that scale formation is promoted selectively on particles of the treated feed solution rather than the filtering means filtering the treated feed solution.

The present invention can comprise a system for filtration further comprising a treated feed solution and a membrane, more specifically, but not limited to, a spiral wound membrane module adapted to receive the treated feed solution. The treated feed solution can comprise feed solution treated with pulsed power to promote scale formation selectively on particles of the feed solution rather than the spiral wound membrane module. The pulsed power or other treatment devices can also destroy microorganisms that may be in the feed solution. The membrane module can have a feed spacer adapted to allow scale covered particles of the treated feed solution to flow substantially unobstructed through the feed spacer.

The present invention can comprise a filtration system further comprising a treatment device, such as a charge neutralization device, for treating feed solution, and a spiral wound membrane module adapted to receive feed solution treated by the charge neutralization device. The treated feed solution can comprise feed solution treated with pulsed power from the charge neutralization device to promote scale formation selectively on particles of feed solution rather than the spiral wound membrane module. The feed solution pre-treatment device may also destroy microorganisms in the fluid stream. The module can have a feed spacer structure adapted to allow scale covered particles of the treated feed solution to flow substantially unobstructed through the feed spacer.

According to yet another aspect of the present invention, there is provided a method for filtration. The method can comprise treating a feed solution for one or more filtration devices such that scale formation is selectively promoted on particles of the treated feed solution rather than the filtration device filtering the treated feed solution, and passing the treated feed solution through a feed spacer structure of at least one filtration device such that scale covered particles of the treated feed solution flow substantially unobstructed through the feed spacer structure.

The present invention can comprise a method for filtration further comprising treating a feed solution for a spiral wound membrane module with an electromotive force device such as pulsed power to promote scale formation selectively on particles of the feed solution rather than the spiral wound membrane module, and passing the treated feed solution through a feed spacer structure of the spiral wound membrane module, wherein the scale covered particles of the treated feed solution flow substantially unobstructed through the feed spacer structure.

The adapted feed spacer of the aforementioned systems and methods can be a feed spacer integrated in the membrane of the module and have an open feed spacer design. Alternatively, the feed spacer can be a specially designed feed spacer mesh that has an aerodynamic cross section relative to the fluid flow path so that the scaled particles in the treated fluid stream can easily pass around the feed spacer mesh and through the spiral wound element. The energy for treating the feed solution can be an electromotive force such as magnetic, electromagnetic, pulsed power, and electrostatic, or hydro-dynamic, or a combination thereof.

The present invention can comprise a spiral wound membrane module having a membrane comprising a thin film nano-structured membrane material and an integrated feed spacer having an open feed spacer design.

The present invention can comprise a spiral wound membrane filtration system utilizing embossed membranes and pulsed power, magnetically, electromagnetically, electrostatic, or hydro-dynamically treated feed solution to precipitate scale as crystals in the bulk fluid solution rather than on the membrane surface. These treatment devices may also destroy microorganisms in the feed solution thereby reducing the potential for biofilm formation on the membrane surface. With conventional spiral wound membranes, particles, biofilm, and scale are collected in the feed spacer mesh as well as on the membrane. By adopting an embossed membrane, fluid solution particles that are treated by electro-magnetic or other means are allowed to flow in the feed channel and are not obstructed or blocked by the feed spacer. Separation of the membrane is achieved by embossing the membrane, by printing posts on the membrane surface, by applying a decal pattern to the membrane, or other such means for creating a pattern directly on the membrane surface. Obstructions in the feed channel are removed. By changing charge characteristics of the scale forming material in the feed solution, scale does not form on the membrane material, but rather forms small particles or “rocks” in the bulk fluid solution. The particles are carried along in the bulk feed solution and are allowed to pass out of the reject end of the spiral wound element. In a further embodiment, the particles that are formed also accumulate ions that are in the feed solution and reduce concentration polarization in the membrane element, and further reduce the osmotic pressure requirements to drive the fluid through the membrane material by virtue of the fact that the ion concentration is lower than it would be otherwise.

According to another aspect of the present invention, there is provided a filtration membrane system. The filtration membrane system can have a plurality of spiral wound membrane elements disposed in a common pressure vessel for receiving feed solution, wherein a first spiral wound membrane element of the plurality of spiral wound membrane elements in the pressure vessel has a first feed channel spacer, and wherein a second spiral wound membrane element of the plurality of spiral wound membrane elements, disposed downstream from the first spiral wound membrane element, has a second feed channel spacer, and wherein the second feed spacer has a height that is less than the height of the first feed channel spacer.

In yet another embodiment of the present invention, RO systems are often configured in multi-stage systems where the product water from the first stage is the feed water to the second stage. This provides for further purification of the feed stream for low conductivity water applications such as those in the pharmaceutical or semiconductor industries. In these applications, electromagnetic force devices such as pulsed power modules can be added in front of each stage to further reduce the potential for scale formation or biofilm in subsequent stages, to help reduce the ion concentration in the feed stream of the subsequent stages, so that the product water quality is further improved.

An additional embodiment of the current invention utilizes nano-structured membrane material to increase permeation rates through the membrane. These nano materials can be zeolites and/or carbon nano-tubes. In the current state of the art, these spiral wound elements are constructed with conventional mesh type feed spacer. By combining the features of this embodiment with the features of embossed thin feed spacers, permeation rates that are many times conventional permeation rates are theoretically achievable. One of the disadvantages of higher permeation rates is faster development of concentration polarization along the length of the membrane element. Thin feed spacers generate higher shear in the fluid and help reduce concentration polarization, thereby offsetting the positive effect of higher permeation rates. Likewise, formation of scale around particles in the fluid stream via pulsed power or other methods, reduces the formation of scale that is associated with higher concentration polarization and precipitation of scale due to higher permeation rates of nano-composite membranes.

In yet another embodiment of the present invention, anti-bacterial materials are embedded in the membrane material to eliminate the buildup and accumulation of biological material on the membrane surface.

In yet another embodiment of the present invention, the membrane material is a chlorine tolerant material comprising cellulose acetate or sulfonated copolymers, or other materials, which allows the use of free chlorine to remove biological and organic material from the membrane surface. In yet another embodiment of the present invention, alginic acid may be utilized to remove silica scale from the membrane surface. This combination of technologies can provide many times the permeation rate as conventional spiral wound elements, and can significantly reduce membrane fouling which is the leading cause of maintenance and failure of spiral wound membrane elements.

Spiral wound filtration systems typically comprise more than one element in series in a pressure vessel. In such a configuration, the feed solution exiting one element, now defined as the reject from the first element, is the feed solution entering the subsequent element in the pressure vessel. The ion concentration in the reject solution from the first element is higher than the feed solution entering the first element since a portion of the fluid entering the first element has passed through the membrane leaving the ions behind which creates a higher ion concentration (aka concentration polarization) as the feed solution exits the first element. Likewise, the volume, and velocity, of the feed solution leaving the first element is smaller as it enters the subsequent element in the pressure vessel. As the feed solution progresses through the various membrane elements in series in the pressure vessel, the velocity of the feed solution decreases as the ion concentration (concentration polarization) increases. As the ion concentration increases toward the end of the pressure vessel, precipitation of the ions can cause scale to form in the feed channel of the membrane element. This phenomenon typically establishes the recovery, or the limit of the ratio of permeate production (product water) to the feed water volume for a particular membrane system.

In another embodiment of the present invention, the feed spacer thickness of subsequent spiral wound elements in a single pressure vessel can be sequentially reduced in order to maintain the velocity profile of the feed solution in the subsequent elements. By maintaining a relatively constant feed solution velocity profile through the pressure vessel, the critical flux can be maintained thereby reducing the probability of ion precipitation from occurring, thereby reducing the opportunity for scale formation in the elements.

In some applications, such as existing shipboard marine desalination applications, an increase in the amount of produced water may not be a key objective because a population increase on the ship may not be anticipated. In this instance, incorporation of thinner feed spacers for the purpose of increasing the volume of water treated may not be necessary. However, embossed or printed feed spacer technology may be needed in conjunction with pulsed power to facilitate scale formation on particles so that the scale particles can easily pass through the membrane element. Also, the feed spacer and pulsed power can be adapted such that, in addition to the aforesaid facilitation of scale formation, microorganisms in the feed solution are destroyed thereby reducing the potential for biofilm formation on the membrane surface. In this case, the feed spacer thickness may be the same as mesh type feed spacers currently available. While the volume of water treated may be the same as originally intended, the use of open feed spacer technology coupled with pulsed power or other pre-treatment technologies may be utilized to facilitate scale control or removal.

In yet another embodiment of the present invention, management of an existing facility may not want to make changes to the facility. However, there may be a desire to increase the production of product water, or to reduce the volume of the reject stream from the plant, or both. In these instances, a permeate enhancement module may be utilized. In this embodiment, a separate skid mounted RO module can be configured for the specific purpose of extracting more product water from the reject stream of the existing plant. By utilizing pulsed power technology to reduce scale formation, and by combining this with open channel feed spacers, additional water can be processed without formation of scale in the skid mounted module. The positive effects of this configuration are that more product water can be processed, and the reject stream can be reduced in volume in order to reduce costs associated with disposal of the reject stream.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 is a schematic view of a membrane system;

FIG. 2 is a diagram showing the normalized flow curves between membrane sheets in a spiral wound membrane element;

FIG. 3 is an isometric view of a partially wound spiral wound membrane module;

FIG. 4. is a view of an embossed membrane sheet of the membrane module of FIG. 3;

FIG. 5 is a schematic diagram of a system for filtration according to one embodiment;

FIG. 6 is a view of scale formation on membrane sheets with particles in the water flow between two membrane sheets in a spiral wound membrane element; and

FIG. 7 is a view of carbonate scale coated particles flowing in a fluid stream between two membrane sheets in a spiral wound membrane element.

FIG. 8 is a performance graph of fluid flowing through a spiral wound membrane element.

FIG. 9 is a diagram of a two stage membrane module system.

FIG. 10. is a diagram of the fluid velocity profile and scale formation potential profile of a conventional spiral wound RO membrane system.

FIG. 11 is a diagram of the fluid velocity profile and scale formation potential profile of a spiral wound membrane system with membrane elements having variable thickness feed spacers.

FIG. 12 is a diagram of a reverse osmosis permeate enhancement module.

### DETAILED DESCRIPTION

The particular values and configurations discussed in these non-limiting examples can be varied and are cited merely to illustrate at least one embodiment of the present invention and are not intended to limit the scope of the invention.

Technical features described in this application can be used to construct various filtration systems and methods. For example, a system for filtration can have one or more treatment devices for treating feed solution and one or more filtration devices for receiving the treated feed solution. The treatment device(s) can be adapted to treat the feed solution such that scale formation is selectively promoted on particles of the treated feed solution rather than the filtering device(s) filtering the treated feed solution. In one example, the filtration device can have a feed spacer adapted to allow scaled covered particles of the treated feed solution to flow substantially unobstructed through the feed spacer.

It has been identified that filtration systems can vary in removal efficiency depending on the type of filter material and construction. For example, in membrane filtration, the filtration device is a membrane of a type that includes micro-filtration, ultra-filtration, nano-filtration, and reverse osmosis. Construction techniques include flat sheet membrane systems, hollow fiber membrane systems, and spiral wound membrane elements. Membrane systems are subject to fouling from scale and biofilm that may form on the membrane surface. These fouling mechanisms create higher pressure requirements (higher energy consumption), losses in efficiency, and higher maintenance requirements.

Systems and methods for membrane filtration according to the illustrative embodiments are suitable for use in fields of membrane filtration including, but not limited to, RO filtration and non-RO filtration such as nano-filtration, ultra-filtration, micro-filtration, separations, and other processes.

As an example, spiral wound membrane filtration elements are subject to fouling from scale formation and biofilm on the feed side of the membrane. In conventional spiral wound membrane designs, the membrane sheets are spaced apart on the feed side of the membrane with a plastic mesh type material. The feed water must pass over, around and through the mesh feed spacer as the fluid flows from one end of the element (feed side) to the far end of the element (reject end). As the feed solution flows further down the length of the element, particles and ions are rejected from the fluid, and the concentration of those ions and particles increase near the discharge end of the spiral wound element. This high concentration of particles and ions causes the materials in solution to precipitate out and form scale. The scale forms on the membrane sheet as well as in the feed spacer mesh. Scale is particularly a problem with high hardness ground water. In surface waters or seawater, biological materials in the feed stream allow biofilm to form in the feed spacer mesh and interact with the scale to increase the severity of the problem. The scale and biofilm cause degradation of the performance of the spiral wound element which is typically measured by the increase in pressure from the feed end of the element to the reject end, typically referred to as the trans-membrane pressure. This increase in pressure indicates the need to take the membrane pressure vessel out of service and then requires that the system be cleaned, typically by chemical treatment.

For the purpose of explaining the apparatus and methods of the embodiments, reference will first be made to a non-limiting example in which the filtration system is for removing dissolved solids from water by the process known as Reverse Osmosis (hereafter, RO). RO renders the water thus treated potable and safe for human consumption from the standpoint of the dissolved solids (hereafter the Total Dissolved Solids or TDS) concentration. As will be explained hereinafter, apparatus and methods of embodiments can be used to provide an alternative means to increase the production of potable water per unit size of RO system.

### The Function of Reverse Osmosis

Osmosis is the process whereby water moves across a semi-permeable membrane separating aqueous solutions of dissimilar TDS concentrations to achieve a balance in the chemical potential of the water on either side of the semi-permeable membrane. Because the chemical potential of the water includes the pressure head, the osmosis phenomenon is demonstrated, and quantification of the osmotic potential or osmotic pressure of a solution is made, simply by allowing the heights of two columns of two aqueous solutions containing dissimilar TDS concentrations and connected through a semi-permeable membrane, to come to equilibrium and measuring the difference in heights of the solution columns at equilibrium. In reaching this osmotic equilibrium, water moves from the column containing the aqueous solution with the lower TDS concentration to that containing the higher until the chemical potentials of the water in each column are equal.

In Reverse Osmosis (RO), pressure is applied to the aqueous solution containing the higher TDS concentration, thus increasing the chemical potential of the water in that solution, and causing water to move in the reverse direction across the semi-permeable membrane. This process produces water of a lower TDS concentration. The RO process is used commercially to produce water of a lower TDS concentration from an aqueous solution containing a higher TDS concentration. Stated in lay terms, but incorrectly in terms of actual process, RO is used to remove TDS from water, or to “desalinate” the water. Commercial RO units range in size from small enough to fit under the sink of a household kitchen and supply water containing lower TDS to the household, to systems large enough to supply water of lower TDS to a large city. Commercial RO units have found wide application from desalinating seawater, to desalinating brackish water, to removing organic contaminants, to removing micro-organisms, to removing the chemical components causing hardness in water, a process known as “membrane softening”.

### RO Technology

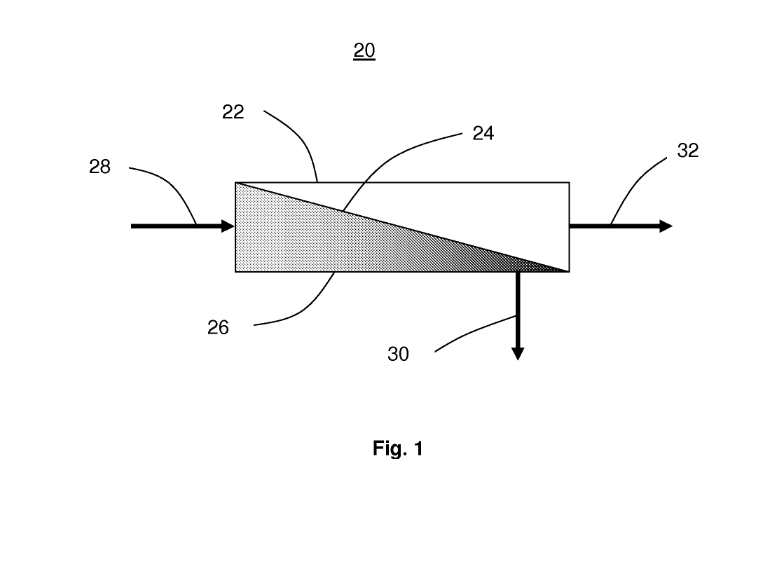

As shown schematically in FIG. 1, RO unit 20 consists of module 22 containing RO membrane 24, enclosed by pressure housing 26. Housing 26 withstands the applied pressure on feed solution 28 (water to be desalinated), and has plumbing which directs feed solution 28 properly through module 22, or modules in series, and directs reject solution 30, or retentate (salt-enriched water), and permeate 32, (desalted water or product), to exit ports on housing 26 in such fashion that the solutions do not mix.

### Reverse Osmosis System Hydraulics

In a traditional spiral-wound module, a feed solution enters through feed spacer openings and is driven under pressure in cross-flow to the membrane, i.e., parallel to the membrane surface. Desalted (or reduced TDS) permeate passes through the membrane perpendicular to the membrane surface into the permeate carrier. Reject (retentate) continues in cross-flow across the membrane surface to the exit from the housing. Additional permeate is removed through the membrane as it proceeds the length of the module.

In order for reverse osmosis to occur, the applied pressure (ΔP) on the feed solution must, at a minimum, equal the osmotic pressure (π) of the solution at the active surface of the membrane. In order for practical fluxes (volume/unit time/unit area of membrane surface, commonly gallons per square foot per day, abbreviated gfd) of permeate to pass through the membrane, ΔP must exceed π; the flux (Jᵥ) (also called membrane permeability) of permeate is approximately proportional to the operating pressure (ΔP−π). The proportionality constant is called the specific permeability (J_{v sp}) with units of volume/unit time·area·pressure (commonly, gallons per day per square foot per pounds per square inch gauge pressure, abbreviated gfd/psig).

The osmotic pressure, π, of an aqueous solution is proportional to the TDS concentration. Thus, as the feed solution passes through the module and has permeate removed from it, the TDS of the remaining solution (the reject) increases and π also increases. The increase in TDS by this process is, to a first approximation, 1/(1−Δ) where Δ is the permeate recovery defined as the ratio of permeate flow to feed solution flow through the RO unit. Values of Δ are typically 0.1-0.3; thus values of 1/(1−Δ) rarely exceed 1/0.7, or 1.43.

A more important process, in terms of RO performance, is known as concentration polarization. As permeate passes through the membrane, a net lateral flow (toward the membrane surface) of feed solution must occur to replace the permeate lost from the feed solution. As a result of this net lateral flow, dissolved salts accumulate at the membrane surface, increasing the TDS at the membrane surface above that of the bulk feed solution. When this TDS accumulation at the membrane surface, or concentration polarization occurs, three things happen and all of them are detrimental from the standpoint of RO performance: (i) the osmotic pressure of the fluid at the membrane surface increases, thereby increasing the operating pressure; (ii) flux of salt (or other solids) through the membrane can increase, and (iii) carbonate scale can begin to precipitate out of solution causing scale to form on the membrane surface or in the feed spacer. In general, the flux of salts, or solids, across the membrane is proportional to the gradient of salt concentration across the membrane, but independent of the operating pressure. The flux of permeate, however, is substantially proportional to the operating pressure. The net result of detrimental concentration polarization is reduced permeate flux and a potentially higher TDS concentration in the permeate.

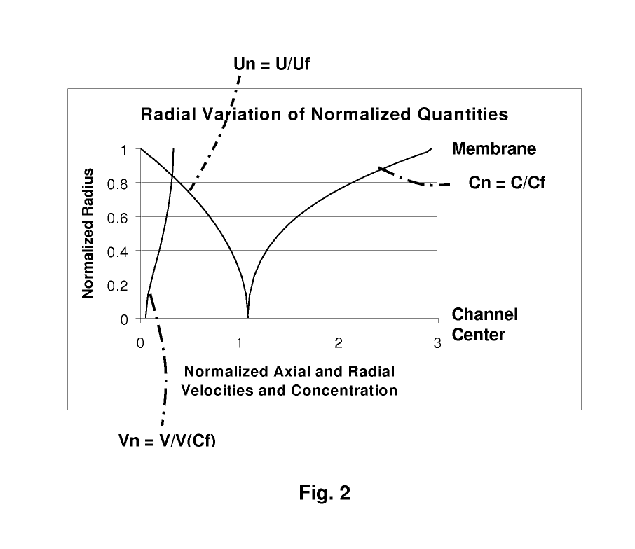

Dissolved salt (or solids) accumulation through advection is balanced by diffusion of dissolved salts (or solids) under a concentration gradient, and by fluid shear, back into the bulk feed solution. Nevertheless, the effect of concentration polarization is substantial as illustrated in FIG. 2.

FIG. 2 shows a plot of variation in normalized axial fluid velocity (Uₙ), radial fluid velocity (Vₙ) and TDS concentration (Cₙ) with distance from the center of the channel to the membrane surface (J_{v sp}=0.30 gfd/psig; Δ=0.445). The results presented in FIG. 2 were obtained from a fluid dynamic model of a 20 mil (0.05 cm) wide channel containing a 10 g/L NaCl feed solution moving in cross-flow to the membrane axis, modeled in two dimensions. The TDS concentration is seen to increase from the center of the channel (Normalized Radius 0) to the membrane surface (Normalized Radius 1) by a factor of 2.9, ie. TDS 2.9 times more concentrated at the membrane surface than in the bulk feed solution.

The degree of concentration polarization varies with the recovery (Δ), the specific permeability (J_{v sp}), the TDS of the feed solution, the velocity of the feed solution in the module which affects the fluid shear, and several other factors; the degree of TDS increase discussed above (2.9 times the bulk feed solution) is but one illustration of detrimental concentration polarization.

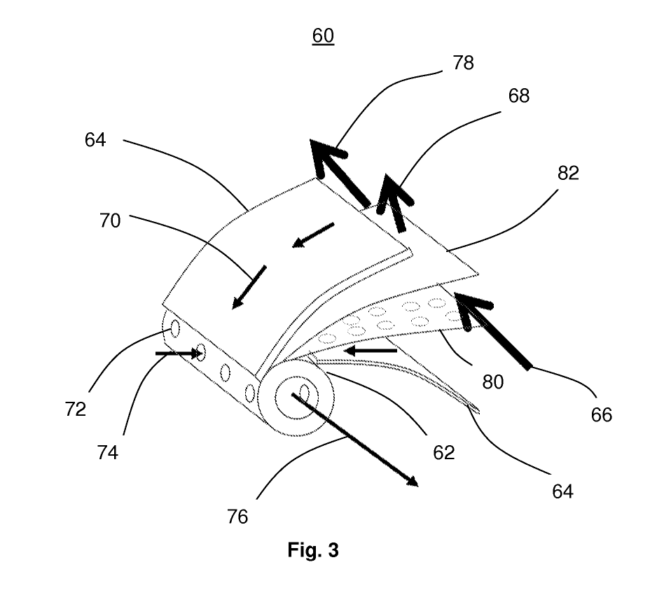

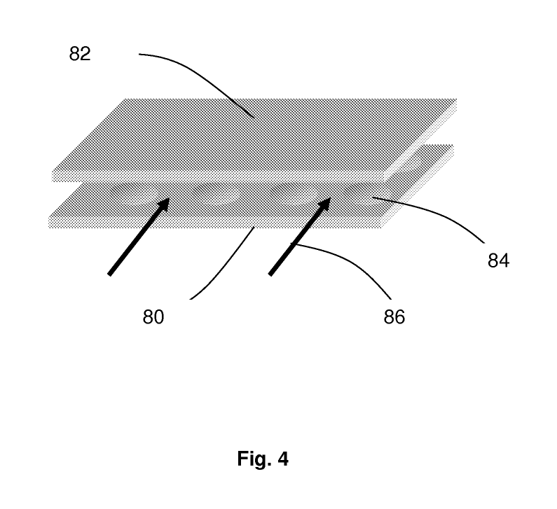

FIG. 3 illustrates a graphic example of an embossed membrane spiral wound module according to one embodiment. The module is an RO type module 60 and has a permeate carrier 68, and membrane 82, 80 wound together around center collection tube 62 (e.g., polypropylene, PVC, etc.) into a cylindrical shape. As best shown in FIG. 4, the feed spacer is integrated in membrane 80 and comprises dimples 84 embossed in membrane 80 or printed on membrane 80 in order to provide separation between membranes 82 and 80. Two distinct advantages of embossed or printed membranes are (i) allow for thinner feed spacers so that more membrane material can be wrapped in the same housing, and (ii) there is much less obstruction to the treated feed solution flow 86 and fewer places for particles and scale to form between the membranes.

Membranes 82 and 80 typically comprise a polypropylene fiber support sheet covered by a porous polysulfone, which further comprises a cast layer (for example, but not limited to, approximately 0.1 to approximately 1 μm) of a polyamide. Of course, membranes are not limited to materials comprising polypropylene, polysulfone, and/or polyamide because other materials, e.g., metal, ceramic, sulfonated copolymers, nano structured materials, carbon nanotube structured materials, etc., are known in the art of filtration. In a typical membrane, polyamide forms an active membrane surface, or membrane layer, i.e., the layer that is primarily or solely responsible for rejecting TDS from a feed solution and for allowing passage of permeate. In general, at least one other membrane layer is present for physical support of the active layer. Of course, depending on the particular use, the “support” layer optionally comprises other functions. For example, but not limited to, a catalytic support layer or support layer for other useful material.

Again referring to FIG. 3, high TDS feed water 66 under pressure enters element 60 through feed spacer integrated in membrane 80, travels through the feed spacer and out the far end of feed spacer 80 as reject (high TDS) solution 78. Since the feed spacer passage is relatively open, the pressure drop from the entrance end of the feed spacer to the exit end of the feed spacer is essentially the same. In other words, feed water 66 and reject solution 78 are approximately the same pressure. As feed water 66 is exposed to the feed spacer side of membrane 80, water molecules are forced through membranes 82, 80 and ions are rejected to feed water 66 flowing along the feed spacer. Low TDS permeate water 68 enters porous permeate carrier 64 and flows spirally 70 around permeate carrier 64 until it enters permeate passage holes 72 into the inside of center tube 62 and comes out the end of center tube 62 as product water 76. In operation, the components of FIG. 3 are wrapped into a long cylindrical tube and the outside of the assembly is taped to prevent element 60 from unwinding. In operation, element 60 is housed in a pressure vessel that can easily withstand the feed pressure. Center tube 62 is sealed from the pressure vessel so that product water 76 is not mixed with feed water 66 or reject solution 78.

Permeate carrier 64 is for example, but not limited to, a highly porous thin polypropylene sheet which collects permeate 68 after it has passed through membranes 82,80 which has removed a fraction of the TDS from feed solution 66, and conveys permeate 68 to center tube 62 for collection.

The embossed or printed membrane can have patterns at variable spacing to maximize turbulence and reduce the effects of concentration polarization. While conventional mesh type feed spacers are in the range of 0.025 inches (0.635 mm) thick, computational fluid dynamic modeling and experimental results with thin feed spacer membranes that are 0.003 inches (0.076 mm) spacing, demonstrates that twice as much membrane sheet material can be wrapped in to the same size element as conventional mesh type feed spacer elements that are approximately 12 inches (305 mm) in length. At a feed spacer thickness of 0.003 inches (0.076 mm), the pressure drop across a 12 inch (305 mm) long element is less than 5 psi (34 kPa) at an applied pressure of 800 psi (5515 kPa). Commercial membrane elements also come in longer length sizes. The feed spacer thickness for these longer length elements will need to be wider, but will be substantially less than the conventional thickness of 0.025 inches (0.635 mm).

Examples of embossed and other thin feed spacers that can be used in system 60 (FIG. 3) are disclosed in U.S. Pat. No. 6,632,357 to Barger et al entitled “Reverse Osmosis (“RO”) Membrane System Incorporating Function of Flow Channel Spacer”, and U.S. Pat. No. 7,311,831 entitled “Filtration Membrane and Method for Making Same” to Bradford, et al, which are incorporated herein by reference in their entirety.

One of the key limitations to increased permeation is the increase in concentration polarization on the feed side of the membrane. The increase in concentration polarization has two primary negative effects. The first is the increase in ion concentration on the feed side of the membrane that increases the osmotic pressure required to drive the fluid molecules across the membrane. The second is a by-product of higher ion concentration, and that is a higher propensity to precipitate carbonate scale from solution and form scale on the membrane surface and the feed spacer mesh. This restricts flow through the membrane surface as well as flow down the length of the membrane element.

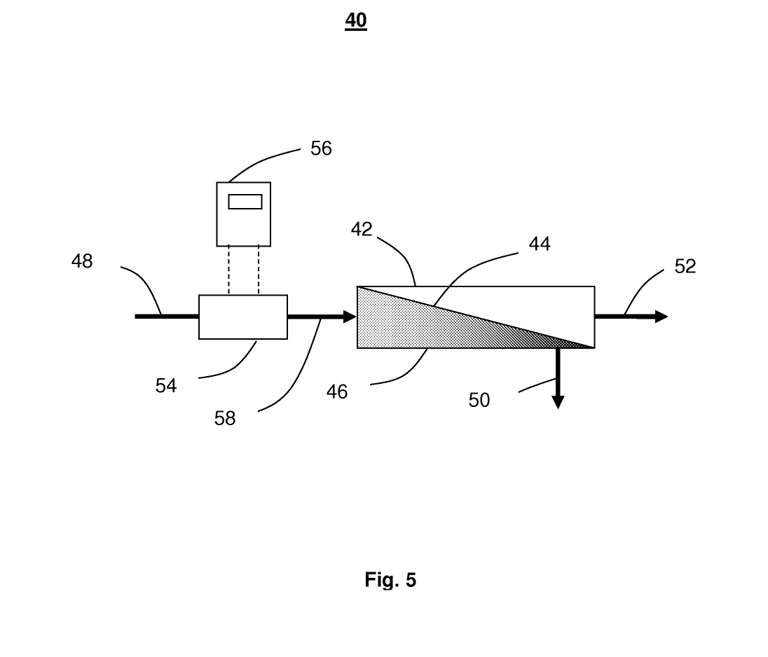

Reference will now be made to FIG. 5, which illustrates a system for filtration according to one embodiment. System 40 has a treatment device 54 for treating feed solution, and a filtration device 42 for filtering the feed solution. In this example, the treatment device is a charge neutralization device 54 for treating feed solution 48, and the filtration device is a spiral wound membrane module 44, adapted to receive feed solution treated by the charge neutralization device. Spiral wound membrane module 44 can be for example the spiral wound membrane module of FIG. 3. Treated feed solution 58 is feed solution 48 treated with pulsed power from charge neutralization device 54 to promote scale formation selectively on particles of feed solution rather than the spiral wound membrane module. Particle charge neutralization device 54 comprises a pulsed power, magnetic, electro-magnetic, electro-static, hydrodynamic or other device capable of causing scale to form on particles in feed fluid stream 48 before entering membrane element housing 46. These pre-treatment devices may also destroy microorganisms in the feed solution. As will be explained in more detail below, membrane module 44 incorporates embossed or printed feed spacers adapted to allow scale covered particles of the treated feed solution to flow substantially unobstructed through membrane module 44.

It has been identified that concentration of ions often leads to carbonate scale precipitating out of solution and forming scale on the surfaces of the membrane. Various technologies that employ pulsed power, magnets, electro-magnets, electro-static, and hydrodynamic devices have been identified as being useful for treating feed solution 48 (FIG. 5). “Physical Water Treatment for Cooling Towers”, Cooling Technology Institute paper number TP08-15 by David McLachlan, et al, which is incorporated herein by reference in its entirety, is an example of such technologies. Most of these technologies utilize the Lorentz equation:

F=qE+qv×B
F is the force
E is the electric field
B is the magnetic field
q is the electric charge of the particle (ions, etc.)
v is the instantaneous velocity of the particle and
x is the cross product (used to multiply vectors)
   Where the force due to qv×B calculates the force exerted on a charged particle (ionic, with charge of q) moving with velocity v in a magnetic field B, where x denotes the vector cross-product. The net effect is that the charge on particles and colloids in the fluid stream are neutralized and carbonate scale forms on the particles selectively rather than on the equipment surfaces.

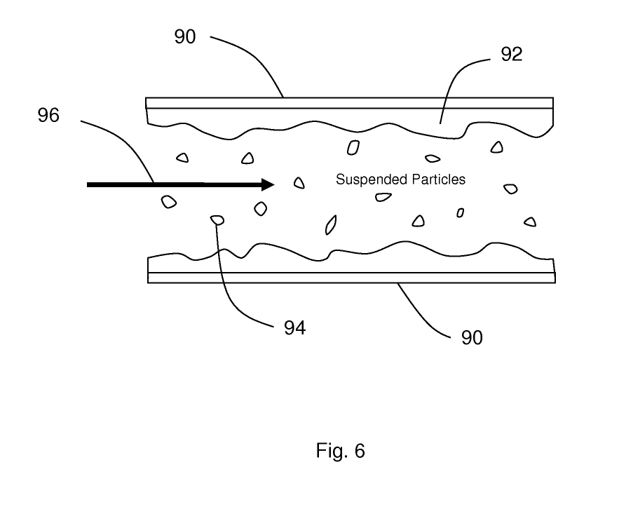

With reference to FIG. 6, in conventional spiral wound membrane filtration, charged particles 94 in fluid stream 96 can flow in the channel without restriction. However, if the ion concentration is high enough, and the appropriate elements are in the solution, carbonate scale 92 (typically calcium carbonate or magnesium carbonate) can precipitate out of solution and will adhere to the walls in the channel, in this case membranes 90. As concentration polarization increases along the length of the spiral wound membrane element, the opportunity for precipitation and scale formation increases dramatically. Concentration polarization and the consequent formation of scale 92 is a limiting factor in the ratio of permeate flow to feed flow, i.e. recovery, in a spiral wound membrane element. While carbonate scale can be removed by acid cleaning techniques, silica scale formation can be particularly problematic in removal.

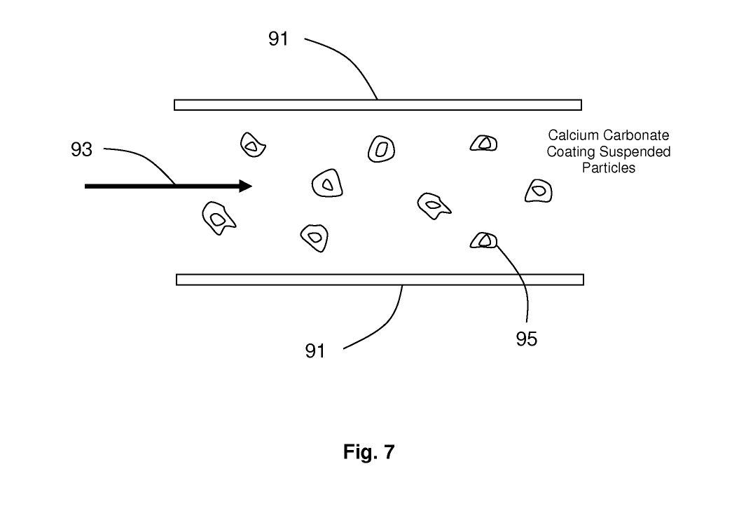

FIG. 7 illustrates the effect of treating the fluid with pulsed, high frequency electromagnetic energy using device 54 (FIG. 5) according to one embodiment. Scale 95 forms on the particles selectively rather than on the channel surfaces 91. Pulsed power technology can facilitate scale formation on particles in the fluid stream, and eliminate the formation of scale on the membrane surface as well as destroying microorganisms in the feed solution. More importantly, it can precipitate ions along the flow path. Ions are removed via particle creation thereby reducing concentration polarization. This allows higher recovery and reduces operating pressure.

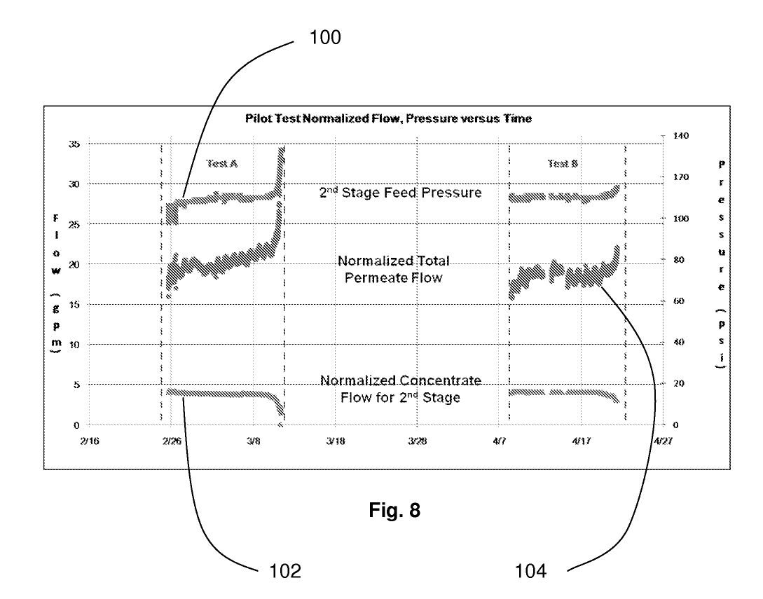

Clearwater Systems of Essex, Conn. has commercialized pulsed power systems to help eliminate scale formation in cooling towers. In an attempt to find other applications of the technology, Clearwater Systems contracted with Corollo Engineers, a national water engineering firm in the United States, to conduct studies to determine if pulsed power technology can have benefits for eliminating scale formation in spiral wound membrane systems. Studies were conducted on conventional mesh type feed spacer spiral wound elements. FIG. 8 represents a typical plot of the test results. In reference to FIG. 8, the data and autopsy of the elements shows that scale did not form on the membrane surface, but rather formed on particles in the fluid stream and created a slurry of scale coated particles. The slurry of scale coated particles accumulated in the feed spacer mesh and caused a blockage of the flow through the feed spacer channels in the element. This is evidenced by the loss of reject flow out of the end of the membrane element, otherwise shown as normalized concentrate flow 102 in the bottom plot of FIG. 8. As normalized concentrate flow 102 decreased due to slurry blockage in the mesh type feed spacer, second stage feed pressure 100 increased as shown in the upper plot of FIG. 8. However, it is clear from the middle plot of FIG. 8, that scale had not formed on the membrane surface, because normalized permeate flow 104, or flow through the membrane surface, increased as the second stage feed pressure increased. This was verified by autopsy of the membrane element. Scale had not formed on the membrane surface. Further, the slurry particles were analyzed and verified that they consisted of calcium carbonate coated particles.

Referring now again to system 40 of FIG. 5, spiral wound element or module 44 utilizes an open feed spacer design. One function of an open design feed spacer is to hold the active surfaces of the membranes apart during the manufacturing process. Another function of such a feed spacer is to ensure exposure of the membranes to treated feed solution and to convey reject (retentate) from the housing. Yet another function of such a feed spacer is to allow scale covered particles of the treated feed solution to flow substantially unobstructed through the membrane module.

An example of the open feed spacer design is provided in the illustrative embodiment of FIG. 3. The open feed spacer design is an embossed membrane 80 of the membrane spiral wound element 60 to allow the scale coated particles to flow through the embossed membrane spiral wound element 60 unobstructed and out of the embossed membrane spiral wound element 60 via reject stream 78 that is connected to membrane element housing 60. Product water, or permeate 76 is discharged from the membrane element permeate tube 62. In this manner, membrane 80 does not become scaled which significantly improves membrane life, maintains system productivity, and reduces maintenance.

With the use of the pulsed power technology, or other similar technology, in combination with the embossed or printed membrane, the feed channel remains clear and the carbonate scale particles can be flushed out of the reject end of the spiral wound element without causing flow blockage in the element. This system can significantly eliminate scale formation in the spiral wound element, help eliminate the formation of biofilms, reduce the requirement for fluid pre-treatment or pre-filtration, and allow for more continuous operation of the membrane system with increased intervals between cleaning, thereby improving system productivity by reducing downtime for maintenance.

Whilst in the aforementioned example, the filtration device 44 is a spiral wound membrane module other types of filtration devices are envisaged including other types of membrane filtration devices and non-membrane filtration devices, such as for example fiber filters. Furthermore, whilst the treatment device 54 is a charge neutralization device for treating feed solution 48, other types of treatment devices configured to treat the feed solution such that scale formation is selectively promoted on particles of the treated feed solution rather than the filtering device filtering the treated feed solution are envisaged. For example, the treatment device can be one of those devices identified hereinbefore as being useful for treating feed solution to form scale on particles selectively.

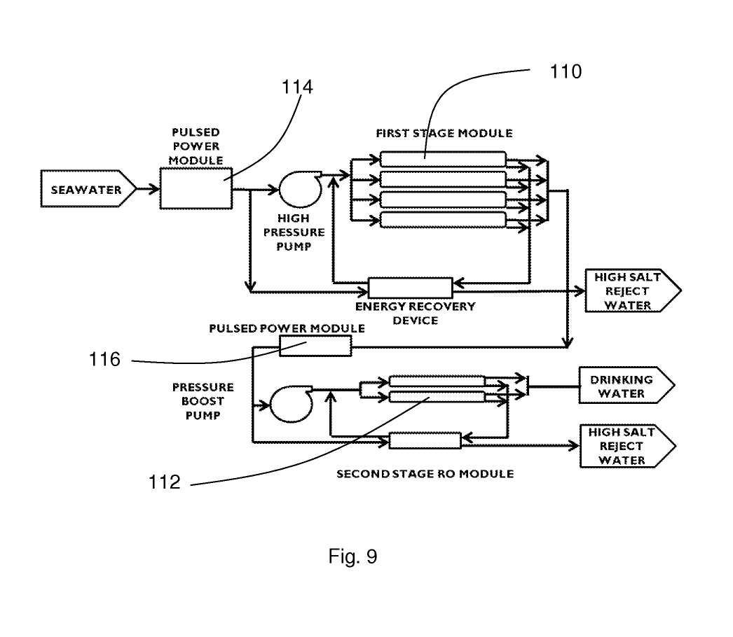

Studies by A. G. Fane—“Critical flux phenomena and its implications for fouling in spiral wound modules” demonstrates the positive influence of increased fluid shear for reduction of membrane fouling. As the fluid velocity (or shear) in the membrane feed spacer channel increases, the chances for precipitation of scale is reduced. Feed spacers that are closer together result in higher fluid velocity that reduce the chances for fouling from precipitation of scale forming agents such as calcium carbonate. It is well known by those in the industry that scale formation occurs at the discharge end of the membrane element where concentration polarization is highest. It is important to note that membrane system designs and hydraulics are significantly impacted by this phenomenon. Most large systems in the field consist of long pressure vessels with a series of spiral wound elements stacked in series. In addition, referring to FIG. 9, large systems are also configured in stages, where first stage pressure vessels 110 are followed by second stage of pressure vessels 112. In the second stage, the TDS concentration of the feed solution is much lower, which results in lower osmotic pressures in the second stage, and permeate with very low TDS concentrations. FIG. 9 further shows the location of primary pulsed power pre-treatment module 114 located in front of first stage pressure vessels 110 and secondary pulsed power pre-treatment module 116 in front of second stage pressure vessels 112.

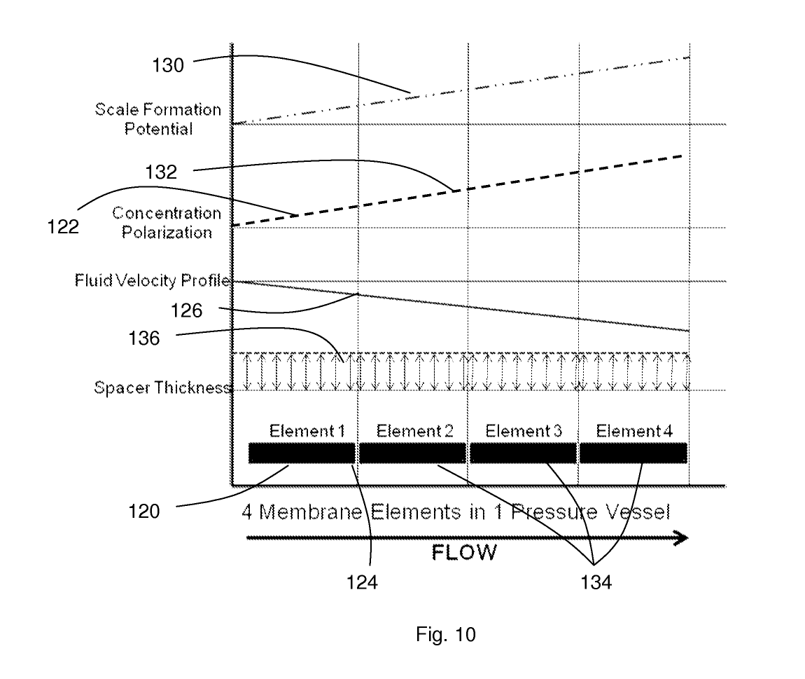

In conventional membrane system designs shown in FIG. 10, two things happen that are detrimental to efficient operation. By means of a non limiting example, in the first element 120 in the pressure vessel stage, the recovery (permeate vs. feed volume) may be, as an example, 50 percent. In that scenario, TDS concentration 122 of the fluid at the discharge end 124 of first element 120 will be twice as high as that entering the element. Likewise, since 50 percent of the water has been driven through the membrane to the permeate side of the membrane, the relative volume of water being discharged in feed channels 136 from the end of first element 120 is reduced by 50 percent. This volume reduction has a corresponding velocity reduction 126 (shear reduction) at the discharge end of first element 120. This is counter-productive to the critical flux that is needed to reduce scale formation potential 130 due to the high concentration polarization 132 that is also present in the feed channel discharge stream. Not only is this phenomenon present in each element, but it is especially true in subsequent element modules 134 in the same pressure vessel.

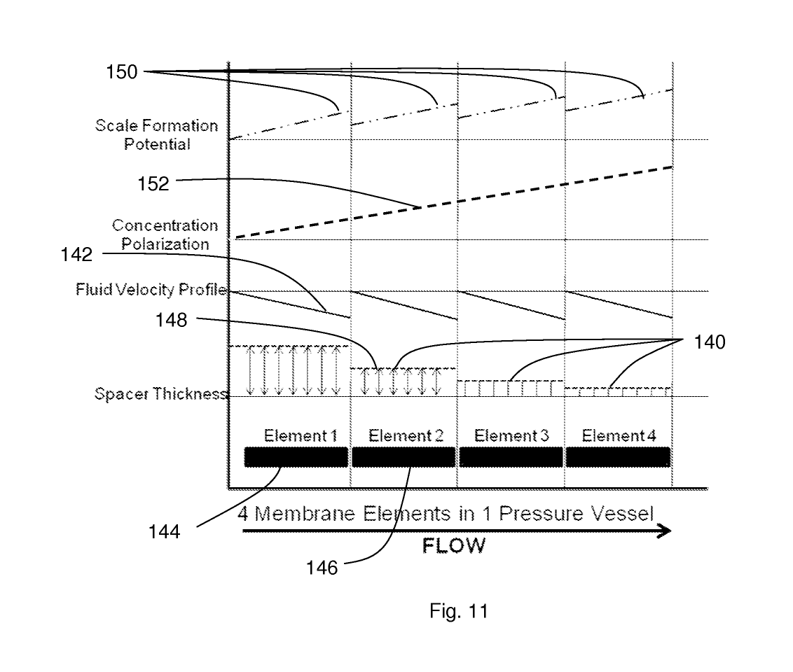

This cascade effect, whereby the volume and velocity of fluid decreases in each subsequent membrane element is not always linear. As the concentration polarization of each subsequent membrane element increases, the recovery of each subsequent element in the cascade within the pressure vessel begins to decrease as the concentration polarization, and osmotic pressure, increases in each subsequent element. By proper design of the feed spacer channel height, however, the velocity profile can be maintained. For example, in one embodiment of the present invention shown in FIG. 11, spiral wound elements can be easily configured with different feed spacer heights 140 so that subsequent membrane elements in a single pressure vessel can maintain the same relative fluid shear 142 (velocity profile) as the previous elements in the pressure vessel—a constant shear membrane configuration.

As a non limiting example whereby the recovery is the same in each element, though theoretically improbable, the feed spacer height of the second membrane element 146 may be half that of the feed spacer height of the first membrane element 144. Likewise, the feed spacer height in the third element may be half the feed spacer height of the second element 146. Other examples are envisaged in which the second membrane element 146 has a feed spacer height that is reduce by some amount relative to the feed spacer height and in which the feed spacer height of the third membrane element is reduce by some amount relative to the feed spacer height of the second membrane element.

By way of a non-limiting example, the feed spacer channel height in first element 144 may be for example 0.030 inches high. In second membrane element 146 the feed spacer channel height may be 0.015 inches high in order to maintain the same fluid velocity. Likewise the feed spacer channel height in the third element may be 0.0075 inches high, and 0.0032 inches high in the fourth element. In this example, the feed spacer channel height is exactly half of the height in the previous element, theoretically maintaining the same velocity in each membrane element feed spacer.

In practical applications, however, the feed spacer height in subsequent membrane elements in the cascade may not be linear, but would more closely match the recovery, or concentration polarization, of the membrane element in question. As a non limiting example, the feed spacer channel height of first element 144 may be 0.030 inches. The feed spacer channel height in second element 146 may be 0.020 inches high, 0.015 inches high in the third membrane element, and 0.010 inches high in the fourth membrane element. Depending on the design of the membrane system, including membrane permeation characteristics, total dissolved solids of the feed solution, and other factors, the feed channel spacer design for each membrane element may need to be tailored to the overall system.

As another non limiting example, there may be four membrane elements in the same pressure vessel. It may be economically advisable to utilize only two different feed spacer channel heights. For example, in the first two elements, the feed spacer channel height may be for example 0.030 inches, but in the last two elements in the system, the feed spacer channel may be for example 0.015 inches high.

As another non limiting example, the membrane system design may include two different stages. The first stage may comprise four membrane elements, all of which have feed spacer channel heights of for example 0.030 inches. The second stage may comprise two membrane elements, all of which have feed spacer channel heights of for example 0.015 inches. Of course, the membrane elements in the first stage may have membrane elements with various feed spacer channel heights, and the second stage may have membrane elements with various feed spacer channel heights.

While the velocity profile 142 through first element 144 is decreasing along the length of that element, the velocity profile in second element 146 in the stage is increased back to the original velocity in the first element due to the thinner feed spacer 148 in second element 146. While the net concentration polarization 152 does not decrease (as shown in the third data line in FIG. 11), the shear velocity 142 is maintained, and this helps reduce the fouling potential 150 on the membrane surface as shown in the fourth data line of FIG. 11.

While several embodiments of the present invention apply to active surfaces, it is understood that the invention is applicable to other surfaces, whether or not these surfaces are used specifically for filtration.

In yet another embodiment of the present invention shown in FIG. 3, membrane 80 may comprise posts, or other protrusions, printed directly on membrane 80 to act as the feed spacer. In yet another embodiment of the present invention, separation of membranes 80, 82 in spiral wound element 60 may comprise a specially designed feed spacer mesh that has an aerodynamic cross section relative to the fluid flow path so that the scaled particles in the treated fluid stream can easily pass around the feed spacer mesh and through spiral wound element 60.

Alternatively or additionally, open channel feed spacer can comprise longitudinal or spiral stringers that do not obstruct flow from a feed to a reject end of the membrane element.

In another embodiment, in addition to using embossed membrane or other thin feed spacers in the spiral wound membrane module, pressure and flow pulsing of the fluid flow in the membrane can be used. This can provide the hydraulic advantages of reducing concentration polarization via an increasing localized vorticity with the appropriate design and spacing of the embossing pattern on the membrane. Examples of pressure and flow pulsing techniques than can be adopted are disclosed in U.S. Pat. No. 7,311,831 to Bradford, et al, entitled “Filtration Membrane and Method of Making Same”.

In one embodiment, a spiral wound element embossed membrane, or other spiral wound integrated thin feed spacer membrane, may further comprise thin film nano-structured membrane materials to increase permeability of the fluid through the membrane surface, thereby increasing concentration polarization. Spiral wound nano-structured membranes using open thin feed spacer designs can be used with untreated feed solution or in conjunction with treated solution to help mitigate the negative aspects of higher permeation rates with nano-structured membranes.

Examples of nano-structured membranes can be found in U.S. patent application publication 20080237126 to Hoek at al which describes thin film nano-composite (TFN) membranes and which is incorporated by reference herein in its entirety. These polyamide membranes with nano particles embedded in the membrane matrix provide significantly improved permeation flow rates (up to 2× increase in permeate flow rates are reported) in conventional spiral wound reverse osmosis elements versus current industry standard polyamide membranes.

Another example of nano-structured membranes can be found in application number WO 2010/147743 entitled “Methods and Systems for Incorporation of Carbon Nanotubes into Thin Film Composite Reverse Osmosis Membranes” and which is incorporated by reference herein in its entirety. Because of high permeation rates claimed by some of these nano structured membranes, the open channel feed spacer height may need to be optimized to accommodate higher feed rates anticipated for these membrane materials, but with acceptable feed space heights needed to keep the trans-membrane pressure drop to acceptable levels. This could be accompanied by thicker permeate carriers on the permeate side of the membrane, or by more membrane leafs to carry away the higher volume of permeate produced in the system.

In yet another embodiment of the present invention, anti-bacterial materials are embedded in the membrane material to eliminate the buildup and accumulation of biological material on the membrane surface.

In yet another embodiment of the present invention, the membrane material is a chlorine tolerant material comprising sulfonated copolymers, or other materials, which allows the use of free chlorine to remove biological and organic material from the membrane surface.

One of the leading causes of failure of membrane elements is biofouling and carbonate scale formation on polyamide membrane surfaces. However, polyamide membrane materials are not tolerant to chlorine treatment to eliminate or destroy the biofilm materials that are forming in the spiral wound element. Cellulose acetate membranes are known to be more tolerant to chlorine. Also, recent research at the University of Texas and Virginia Tech has developed membrane materials from sulfonated copolymers that are tolerant to chlorine exposure. U.S. Patent application publication number 20070163951 to McGrath, et al entitled “Chlorine resistant desalination membranes based on directly sulfonated poly (Arylene Ether Sulfone) copolymers”, which is incorporated by reference herein in its entirety, describes such a membrane material. Utilization of this type of membrane material allows the use of free chlorine solutions for spiral wound membrane cleaning, without damaging the membrane material. In addition, this membrane material can be assembled with the nano-structured technique to combine both advantages in one membrane material.

In addition to biofilm removal, membranes can be damaged by the formation of carbonate scale as well as silica scale forming agents on the membrane surface, or in the feed spacer mesh of the current design elements. Carbonate scale buildup in membrane elements is traditionally removed with the use of citric acid. Silica scale removal has been much more problematic. For silica scale removal, U.S. Patent Application publication number 20090188861 to Higgin entitled “Preventing and cleaning fouling on reverse osmosis membranes”, which is incorporated by reference herein in its entirety, utilizes alginic acid to remove silica scale from membrane surfaces.

In yet another embodiment, the aforesaid spiral wound nano-structured embossed membrane, or other spiral wound integrated thin feed spacer membrane, can be utilized in conjunction with the aforesaid pulse powered feed solution. The effects of increasing concentration polarization as a result of using the thin film nano-structure material can be offset by the positive benefits of scale forming on particles in the fluid stream, and the scaled particles being easily swept from the feed spacer channel by virtue of the unobstructed channels comprising embossed membranes.

The systems and methods for spiral wound membrane filtration according to the illustrative embodiments use an alternative approach to provide a high capacity low fouling spiral wound membrane. These combinations of technologies can provide many times the permeation rate as conventional spiral wound elements, and can significantly reduce membrane fouling which is the leading cause of maintenance and failure of spiral wound membrane elements.

This invention relates to combining a variety of positive effects that increase permeation across the membrane sheet, but that also reduces the deleterious effects of increased concentration polarization on the feed side of the membrane. Taken individually, any single improvement can increase production rates, but taken in combination, they can result in significant improvements in production rates versus conventional processes. An example of a significant benefit is that an existing membrane plant can dramatically improve permeate production with the addition of these elements to the existing pressure vessels, and an increase in pumping capacity. An existing facility can dramatically increase production without increasing the size of the facility.

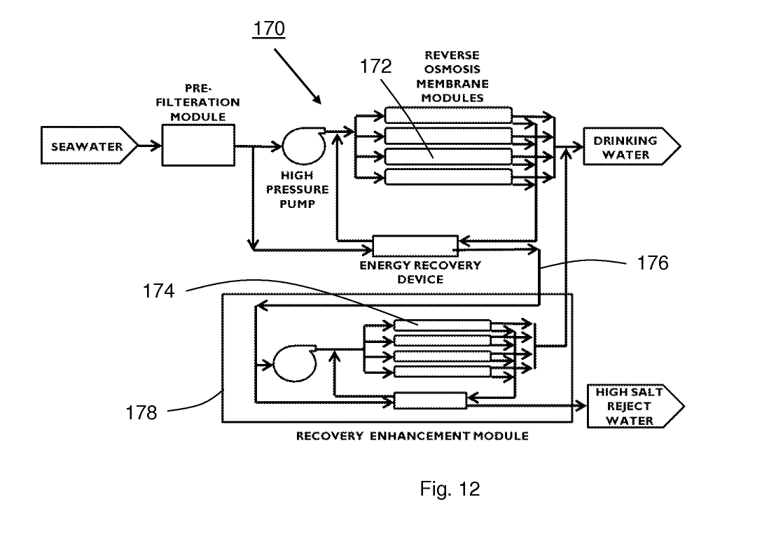

One of the features of thin feed spacers for an existing plant is that higher production capacity through the RO elements will result in higher overall system flow rates, necessitating an expansion to pre-filtration components, the system high pressure pumps, and the piping itself. If an existing plant is reluctant to make the changes associated with increasing flow, an alternate treatment scheme shown in FIG. 12 can still allow existing plants 170 to benefit from thin feed spacer technology. In this embodiment, rather than replacing existing membranes 172, a smaller RO module 174 could be set up to treat reject stream 176, enhancing permeate recovery. This alternate treatment scheme would also offer rapid payback on capital investment. As shown in FIG. 12, reject treatment module 178 would be installed at the end of the RO process.

In yet another embodiment, there are some applications where existing RO plants do not want to increase their existing capacity. There may also be land based RO facilities that do not have the real estate to increase pretreatment equipment. Another example is the RO system in a ship. For shipboard applications, the ship and equipment has already been designed for the number of expected personnel on the ship, and that number is not going to increase based on the ship size. The ship spaces and equipment have already been designed for the water treatment system application, so new space is typically not available for additional pre-filtration modules and additional pumping capacity. However, thin feed spacer technology combined with pulsed power pre-treatment can provide a significant benefit by eliminating scale and biofilm on the spiral wound membrane sheets, dramatically reducing maintenance and increasing service life for the membrane elements. In this embodiment, in order to maintain the same capacity of the thin feed spacer RO element versus existing RO elements with mesh spacers, embossing on the membrane is increased in depth to allow the same feed space between the membrane sheets, which will result in the same square footage of membrane material in the element. Other advantages of this configuration will be much more open feed space channels that will allow scale particles to flow through the element easily, will require less pre-treatment filtration since the space will be much more open allowing larger particles to flow, and will have significantly less pressure drop across the element due to the more open feed spacer channel height.

Clearwater Systems of Essex, Conn. has commissioned studies of pulse power technology in conjunction with conventional mesh type spiral wound elements. In the pulsed power embodiments previously discussed, the pulsed power pre-treatment module was shown to be most effective when placed just before the RO elements and after the particle pre-filtration modules, typically micro filters. In an alternative embodiment, however, it may also be beneficial to add the pulsed power module in front of the pre-filtration system that is common to most RO system designs. The pre-filtration module in most RO system designs is intended to reduce the micron rating of particles entering the RO module to less than 3 to 5 microns. This helps eliminate particle fouling in the RO modules. In yet another embodiment of the present invention, pulsed power modules are installed in front of the pre-filtration system, but also in front of the membrane modules.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

1. A system for filtration, said system comprising
at least one treatment device for treating feed solution; and
at least one filtration device for receiving said treated feed solution; and wherein said at least one treatment device is adapted to treat said feed solution such that scale formation is selectively promoted on particles of said treated feed solution rather than said filtering device filtering said treated feed solution.

2. The system according to claim 1, wherein said filtration device has a feed spacer adapted to allow scaled covered particles of said treated feed solution to flow substantially unobstructed through said feed spacer.

3. The system according to claim 2, wherein said filtration device comprises a membrane filtration element

4. The system according to claim 3, wherein said membrane filtration element comprises a spiral wound membrane element.

5. The system according to claim 3, wherein said feed spacer comprises an open channel feed spacer.

6. The system according to claim 5, wherein said filtration element comprises an embossed membrane having said open channel feed spacer integrated therein.

7. The system according to claim 5, wherein said membrane filtration element comprises a membrane and wherein said open channel feed spacer comprises printed protrusions on said membrane.

8. The system according to claim 5, wherein said membrane filtration element comprises a membrane and wherein said open channel feed spacer comprises protrusions carried on said membrane.

9. The system according to claim 5, wherein said open channel feed spacer comprises longitudinal or spiral stringers that do not obstruct flow from a feed to a reject end of said membrane element.

10. The system according to claim 3, wherein said feed spacer comprises a feed spacer mesh.

11. The system according to claim 1, wherein said treatment device comprises a particle charge neutralization device.

12. The system according to claim 1, wherein said treatment device comprises an electromagnetic force device.

13. The system according to claim 1, wherein said treatment device comprises a pulse power device.

14. The system according to claim 1, wherein said treatment device comprises a permanent magnet device.

15. The system according to claim 1, wherein said treatment device comprises an electro-magnet device.

16. The system according to claim 1, wherein said treatment device comprises an electro-static device.

17. The system according to claim 1, wherein said treatment device comprises a hydrodynamic device.

18. The system according to claim 1, further comprising a pulsing device for pulsing a fluid flow stream of said feed solution in relation to hydraulic flow and pressure.

19. The system according to preceding claim 3, wherein said membrane filtration element comprises a membrane comprising thin film nano-composite (TFN) material.

20. The system according to preceding claim 3, wherein said membrane filtration element comprises a membrane comprising a carbon nanotube structured material.

21. The system according to claim 3, wherein said membrane filtration element comprises a membrane having anti-bacterial material embedded therein.

22. The system according to claim 3, further comprising anti-bacterial materials embedded in a material of said feed spacer.

23. The system according to claim 3, wherein said membrane element comprises a membrane comprising chlorine tolerant material.

24. The system according to claim 23, wherein said chlorine tolerant material comprises sulfonated copolymer material.

25. The system according to claim 3, further comprising
a plurality of said membrane filtration elements disposed in a common pressure vessel for receiving said treated feed solution, and
a plurality of open channel feed spacers for allowing passage of said treated feed solution through said plurality of membrane elements.

26. The system according to claim 25, further comprising
a plurality of pressure vessel stages for receiving said pre-treated feed solution; wherein each one of said plurality of pressure vessel stages comprises
at least one of said membrane elements; and
at least one of said open channel feed spacers for allowing passage of said treated feed solution through said at least one open channel feed spacer.

27. The system according to claim 26, further comprising a plurality of membrane elements in each one of said plurality of pressure vessel stages.

28. The system according to claim 26 further comprising a plurality of said treatment devices; wherein each one of said plurality of treatment devices is operably coupled to a respective pressure vessel stage of said plurality of pressure vessel stages.

29. The system according to preceding claim 26;
wherein said at least one treatment device comprises a treatment device located between said plurality of pressure vessel stages.

30. The system according to claim 26 further comprising a fluid filtration system and a roughing filter system, and wherein said roughing filter system is disposed upstream from said fluid filtration system and wherein at least one of said treatment devices is located upstream from said roughing filter system.

31. The system according to claim 1, further comprising said treated feed solution.

32. A filtration membrane system comprising
a plurality of spiral wound membrane elements disposed in a common pressure vessel for receiving feed solution, wherein a first spiral wound membrane element of said plurality of spiral wound membrane elements in the pressure vessel has a first feed channel spacer, and wherein a second spiral wound membrane element of said plurality of spiral wound membrane elements, disposed downstream from said first spiral wound membrane element, has a second feed channel spacer, and wherein said second feed spacer has a height that is less than the height of said first feed channel spacer.

33. The system of claim 32, wherein said second feed spacer has a height that is less than the height of said first feed channel spacer such that the velocity of the feed solution is substantially maintained through said first and second feed spacers.

34. The filtration membrane system of preceding claim 32, further comprising a treatment device for pre-treating said feed solution such that scale formation is selectively promoted on particles of said treated feed solution rather than said plurality of spiral wound membrane elements filtering said treated feed solution.

35. The system of claim 32, wherein said plurality of spiral wound membrane elements are arranged in succession, wherein each one of said plurality of spiral wound membranes has a corresponding feed channel spacer, and wherein the feed channel spacers are successively smaller in height.

36. A method for filtration, the method comprising
treating a feed solution for at least one filtration device such that scale formation is selectively promoted on particles of said treated feed solution rather than said filtration device filtering said treated feed solution, and
passing said treated feed solution through a feed spacer structure of said at least one filtration device such that scale covered particles of the treated feed solution flow substantially unobstructed through said feed spacer structure.

37. The method of claim 36, wherein treating said feed solution for at least one filtration device comprises treating said feed solution for at least one membrane filtration element, and
wherein passing said treated feed solution through a feed spacer structure of at s least one filtration device comprises passing said treated feed solution through an open feed spacer of said at least one membrane filtration element

38. The method of claim 37, wherein said at least one membrane element comprises a spiral wound membrane element

39. The method according to claim 37, further comprising cleaning said membrane element in alginic acid.

40. A system for filtration, said system comprising
filtering means for filtering a feed solution; and
treatment means for treating said feed solution such that scale formation is promoted selectively on particles of said treated feed solution rather than said filtering means filtering said treated feed solution.

41. The system of claim 40, wherein said filtering means comprises at least one membrane filtration means.

42. The system of claim 41, wherein said at least one membrane filtration means comprises at least one spiral wound membrane element

43. The system of preceding claim 40, wherein said filtering means has a feed spacing means for allowing scaled covered particles of said treated feed solution to flow substantially unobstructed through said filtering means.

44. The system of claim 41, wherein said filtering means has a feed spacing means comprising a open feed spacer carried on a membrane of said membrane filtration means.
